(19) United States
(12) Patent Application Publication
(10) Pub. No.: US 2026/0361263 A1
(43) Pub. Date: Nov. 12, 2026

(54) Tracking Device

(71) Applicant: SL Rack GmbH, Haag (DE)

(72) Inventors: Ludwig SCHLETTER, Haag (DE); Georg BAUER, Haag (DE); Andreas ALTMANN, Kolbermoor (DE)

(73) Assignee: SL Rack GmbH, HAAG (DE)

(21) Appl. No.: 19/658,864

(22) Filed: Apr. 27, 2026

(30) Foreign Application Priority Data
May 6, 2025 (DE) 10 2025 117 356.7

(51) Int. Cl. H02S 20/32; F24S 30/425; F24S 30/00

(52) U.S. Cl. CPC H02S 20/32; F24S 30/425; F24S 2030/134

(57) ABSTRACT

The invention relates to a tracking device for solar and/or photovoltaic modules, comprising at least two posts, a central tube extending at least partially between the posts and rotatably mounted to the posts, an arc segment connected to the central tube in a rotationally fixed manner and having several laterally disposed recesses, and a gear drive with teeth, wherein the gear drive is configured to engage with the recesses by means of its teeth.

### BACKGROUND INFORMATION

### Field of the Disclosure

This application is a translation of DE 10 2025 117 356.7 filed May 06^{th}, 2025. The invention relates to a tracking device for solar and/or photovoltaic modules, comprising at least two posts and an arc segment with several laterally disposed perforations, and a gear drive with teeth, wherein the gear drive is configured to engage with the perforations by means of its teeth.

### Background

EP 3 966 930 B1 discloses a corresponding tracking device. The content of EP 3 966 930 B1 is incorporated in its entirety into this application – especially with regard to the feasibility and possible embodiments of the invention.

A disadvantage of EP 3 966 930 B1 is the presence of a transverse beam with supports for the solar modules. The ends of the arc segment are fastened to the transverse beam. This makes the construction and assembly comparatively laborious and complex.

It is therefore an object of the invention to create a tracking device that allows for simple assembly.

The solution to this object is achieved by the subject matter of the independent claims.

In accordance with the invention, the tracking device is configured for tracking solar and/or photovoltaic modules and/or can be used for this purpose.

### SUMMARY

Tracking can take place, for example, based on the position of the sun. In this way, it can always be ensured that sunlight strikes the solar and/or photovoltaic modules at an optimal angle.

Furthermore, tracking can be performed to adjust the solar and/or photovoltaic modules into a protective position, for example, in the event of a storm, strong winds, hail, and/or a thunderstorm.

Tracking for cleaning purposes is also conceivable. For example, the solar and/or photovoltaic modules can be adjusted to a desired position during rain.

Finally, tracking can be performed so as to set up the solar and/or photovoltaic modules, e.g., at least substantially vertically. In this way, space is created between the rows to allow, for example, agricultural utility vehicles to cultivate the soil.

Tracking can preferably be carried out by means of a control device. For example, this may comprise sensors. Tracking by means of a timer is also conceivable.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 A perspective view of an embodiment of an inventive system,

FIG. 2 A side view of the system in accordance with FIG. 1, and

FIG. 3 A front view of the system in accordance with FIG. 2.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

The tracking device comprises at least two posts.

The posts can, for example, be driven into the ground or be already driven in.

The tracking device comprises a central tube extending between the posts and rotatably mounted to the posts.

Preferably, the upper end of each post can have a bearing pedestal for the central tube.

The central tube can move, preferably pivot, relative to the post.

The tracking device comprises an arc segment connected to the central tube in a rotationally fixed manner.

Preferably, the arc segment is fastened to the central tube by a positive fit. For example, the arc segment can be bolted and/or welded to the central tube. Furthermore, the arc segment and the central tube can also be manufactured as a single piece.

The use of a central tube ensures a simple construction and facilitates assembly. The assembly effort is thus reduced. Furthermore, the load distribution of the modules is improved. Thus, a plurality of modules can be fastened to a single central tube.

Provided on the arc segment are several laterally disposed recesses.

Preferably, the recesses are disposed on a curved portion of the arc segment. For example, the recesses can be placed equidistantly next to one another.

The recesses are disposed laterally, i.e., they do not point downwards on the face side.

A lateral disposition of the recesses is advantageous compared to a face-side disposition. In this way, any forces that arise can be better compensated. For example, a certain amount of play is available if the tracking device sags over time, for instance.

The recesses may preferably be holes that completely penetrate the arc segment. Alternatively, indentations are also conceivable.

The tracking device comprises a gear drive with teeth.

Preferably, the gear drive can be motor-driven, e.g., electrically. For example, the gear drive can be connected to the control device.

The term "teeth" is to be understood broadly here. For example, these can be at least substantially triangular, rectangular, and/or pin-shaped.

For example, the gear drive with teeth may be a, preferably standardized, sprocket.

The gear drive is configured to engage with the recesses by means of its teeth.

Upon rotation of the gear drive, the arc segment and consequently the connected central tube are pivoted to track the solar and/or photovoltaic modules.

It was surprising that the combination of a central tube and a drive via laterally disposed recesses of the arc segment, despite the fundamentally weaker leverage, enables reliable and trouble-free tracking of solar and/or photovoltaic modules over a long period.

Thus, the central tube carries the entire load. Any sagging that may occur can, however, be automatically compensated, due to the laterally disposed recesses.

In contrast to a tracking device without a central tube, assembly is also much simpler.

Further refinements of the invention can also be found in the dependent claims, the description, and the attached drawings.

In accordance with one embodiment, the recesses are configured as perforations, preferably elongated holes.

The perforations can preferably be dimensioned larger than the teeth. This allows for a certain amount of play to compensate for possible sagging.

The elongated holes can be configured, for example, as rectangular slots.

In accordance with a further embodiment, the gear drive is fastened to the post, preferably so as to be height-adjustable.

By virtue of the fact that the central tube and the gear drive are both fastened to the post, sagging does not lead to malfunctions, as these components lower together in unison in such a case.

Preferably, a separate gear drive is provided for each post. The gear drives can preferably be coupled to one another via a common shaft.

The optional height adjustability simplifies assembly and allows for adjustment to the terrain. For example, the gear drive can be mounted, e.g., bolted, at a desired height on the post.

In accordance with a further embodiment, the distance between a mounting plane of the solar and/or photovoltaic modules and two upper terminations of the arc segment, disposed on opposite sides of the central tube, increases from the central tube outward.

The support plane defines a plane in which the solar and/or photovoltaic modules are disposed and/or supported.

The upper terminations can preferably be upper edges of the arc segment.

The upper terminations are preferably angled relative to the support plane. For example, the two upper terminations can be disposed in a V-shape.

This distance prevents contact with the solar and/or photovoltaic modules, thereby minimizing the risk of potential damage.

In accordance with a further embodiment, the arc segment comprises two end spokes disposed on opposite sides of the central tube.

Preferably, the end spokes form the upper terminations of the arc segment.

For example, the end spokes can each be disposed at the outer end of the curved portion of the arc segment or at end regions of the arc segment.

For example, the end spokes may be straight and/or parallel to one another. Alternatively, they may also be angled and/or curved.

Alternatively, the arc segment can be configured as a solid surface. However, the end spokes have the advantage allowing savings to be made on material. Furthermore, the arc segment is permeable to wind as a result.

In accordance with a further embodiment, the end spokes are configured axisymmetrically.

This increases stability, for example.

Furthermore, assembly can be facilitated since the orientation of the arc segment does not matter during assembly.

In accordance with a further embodiment, at least one support spoke is provided between the end spokes.

This can, for example, further increase stability.

In accordance with a further embodiment, the central tube has an angular, preferably rectangular, cross-sectional area.

For example, the cross-sectional area can be square.

Torque can thus be transmitted from the arc segment to the central tube in a simple manner.

In accordance with a further embodiment, the post comprises a pile-driving profile and a bearing device.

Preferably, the pile-driving profile and the bearing device can be fastened to one another, preferably bolted, so as to be height-adjustable. For the purpose of height adjustment, a plurality of holes can be provided, for example.

This allows for simple assembly.

For example, the pile-driving profile can first be driven into the ground. Depending on the terrain, the pile-driving profile can, for example protrude from the ground by between 1.5 m and 2 m. The fine adjustment of the height can then be carried out via the positioning of the bearing device.

The bearing device can, for example, comprise a bearing pedestal. The central tube can be rotatably fastened to the bearing pedestal, for instance.

Finally, the invention relates to a system comprising an inventive tracking device and several solar and/or photovoltaic modules.

For example, the system can comprise a plurality of posts and/or gear drives.

All aspects, embodiments, and features of the invention described herein can be combined with each other, preferably also independently of the specific configuration in the context of which they are mentioned. Preferably, all subject matter of the dependent claims can be combined with each other and with any subject matter of the independent claims.

In general, it is noted that terms such as "a" or "an" do not necessarily mean "exactly one," although this is also possible. Therefore, "a" or "an" can be understood as "at least or exactly one." The use of the singular preferably includes the existence of the components in the plural and vice versa.

It is noted that "vorzugsweise" and "bevorzugt" can be translated as "preferably" in English. A feature introduced by "preferably" is purely optional, may be omitted, and does not constitute a limitation, for example, of the claims.

The invention is described below by way of example with reference to the drawings.

First, it should be noted that the illustrated embodiments are purely exemplary in nature. Thus, individual features can be realized not only in the combination shown but also in isolation or in other technically sensible combinations. For example, the features of one embodiment can be combined as desired with features of another embodiment. The number of posts, tracking devices, as well as solar and/or photovoltaic modules is, in principle, arbitrary.

If a drawing contains a reference symbol that is not explained in the immediately associated descriptive text, reference is made to the corresponding preceding or following explanations in the description of the drawings. Thus, the same reference symbols are used for identical or comparable components in the drawings and are not explained again.

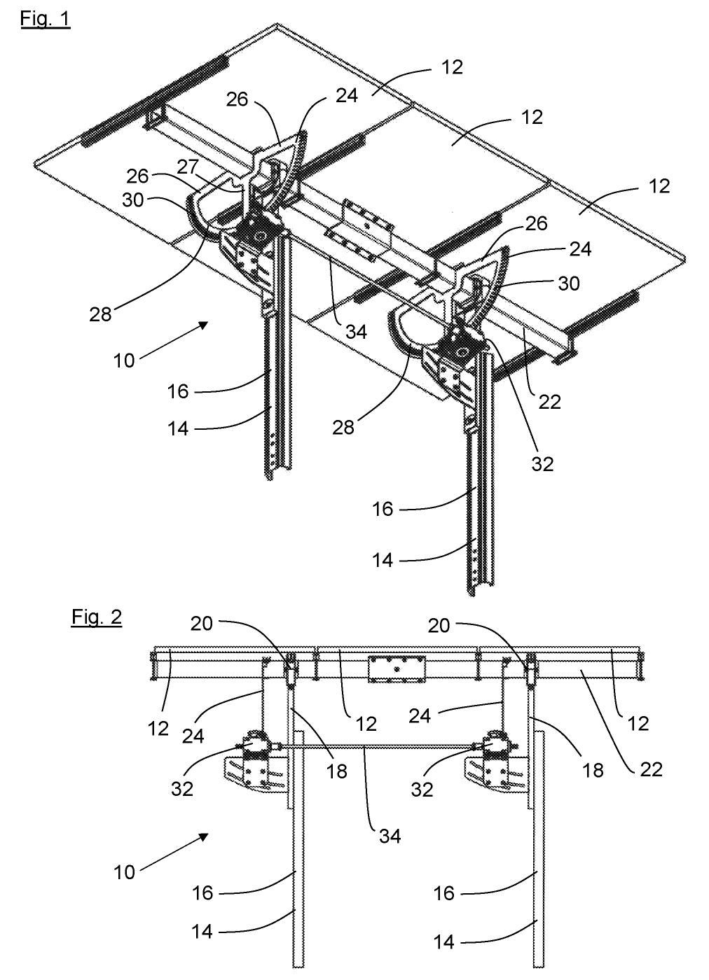

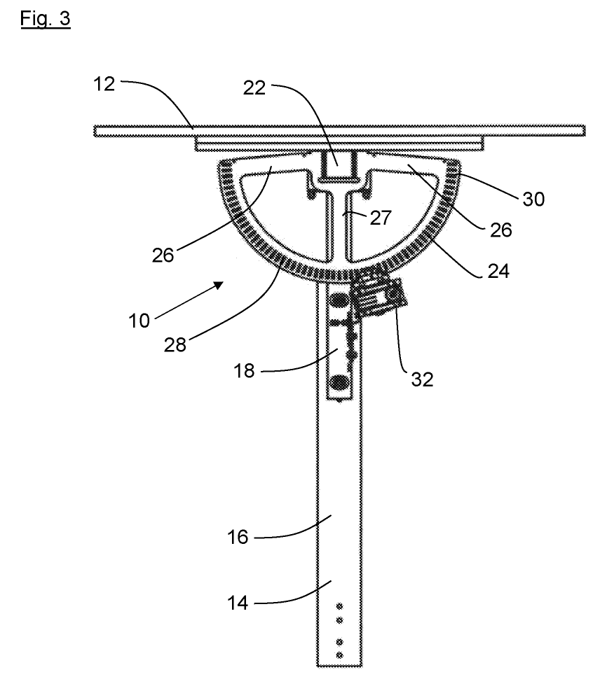

FIGS. 1-3 show a system with a tracking device 10 and several solar and/or photovoltaic modules 12.

The tracking device 10 comprises two posts 14.

The posts 14 comprise a pile-driving profile 16 and a bearing device 18 with a bearing pedestal 20.

A central tube 22 is rotatably mounted on the bearing pedestal 20.

The central tube 22 extends between the posts 14.

An arc segment 24 is connected to the central tube 22 in a rotationally fixed manner.

End spokes 26 form the upper terminations of the arc segment 24. The distance between the two end spokes 26 and the solar and/or photovoltaic modules 12 increases from the central tube 22 outward.

Provided between the end spokes 26 is a support spoke 27.

A curved portion 28 of the arc segment 24 has several laterally disposed recesses 30.

Teeth of a gear drive 32 can engage with these recesses 30.

The gear drive 32 is fastened to the post 14 so as to be height-adjustable.

A plurality of gear drives 32 can be connected via a common shaft 34.

### LIST OF REFERENCE SYMBOLS

10 Tracking device
12 Solar and/or photovoltaic module
14 Post
16 Pile-driving profile
18 Bearing device
20 Bearing pedestal
22 Central tube
24 Arc segment
26 End spoke, upper termination
27 Support spoke
28 Curved portion
30 Recess
32 Gear drive
34 Shaft

Reference throughout this specification to "one embodiment", "an embodiment", "one example" or "an example" means that a particular feature, structure or characteristic described in connection with the embodiment or example is included in at least one embodiment of the present invention. Thus, appearances of the phrases "in one embodiment", "in an embodiment", "one example" or "an example" in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. Tracking device (10) for solar and/or photovoltaic modules (12), comprising
at least two posts (14),
a central tube (22) extending at least partially between the posts (14) and rotatably mounted to the posts (14),
an arc segment (24) connected to the central tube (22) in a rotationally fixed manner and having several laterally disposed recesses (30), and
a gear drive (32) with teeth, wherein
the gear drive (32) is configured to engage with the recesses (30) by means of its teeth.

2. The tracking device (10) in accordance with claim 1,
wherein
the recesses (30) are configured as perforations.

3. The tracking device (10) in accordance with claim 1,
wherein
the gear drive (32) is fastened to one of the posts (14).

4. The tracking device (10) in accordance with claim 1,
wherein
the distance between a support plane of the solar and/or photovoltaic modules (12) and two upper terminations (26) of the arc segment (24) disposed on opposite sides of the central tube (22) increases from the central tube (22) outward.

5. The tracking device (10) in accordance with claim 1,
wherein
the arc segment (24) has two end spokes (26) disposed on opposite sides of the central tube (22).

6. The tracking device (10) in accordance with claim 1,
wherein
the arc segment (24) has two end spokes (26), which are configured axisymmetrically.

7. The tracking device (10) in accordance with claim 1,
wherein
the arc segment (24) has two end spokes (26), wherein at least one support spoke (27) is provided between the end spokes (26).

8. The tracking device (10) in accordance with claim 1,
wherein
the central tube (22) has an angular cross-sectional area.

9. The tracking device (10) in accordance with claim 1,
wherein
the post (14) has a pile-driving profile (16) and a bearing device (18).

10. A system comprising:
a tracking device (10) in accordance with claim 1, wherein the tracking device (10) includes a plurality of solar and/or photovoltaic modules (12).
